(19) United States
(12) Patent Application Publication
(10) Pub. No.: US 2002/0175623 A1
(43) Pub. Date: Nov. 28, 2002

(54) Plasma display panel

(75) Inventors: Yong-Jun Kim, Kyungki-do (KR); Tae-Kyoung Kang, Chungcheongnam-do (KR)

Correspondence Address: LEYDIG VOIT & MAYER, LTD, 700 THIRTEENTH ST. NW, SUITE 300, WASHINGTON, DC, 20005-3960, US

(73) Assignee: Samsung SDI CO., LTD., Kyungki-do (KR)

(21) Appl. No.: 10/046,832

(22) Filed: Jan. 17, 2002

(30) Foreign Application Priority Data
May 26, 2001 (KR) 2001-29252

(51) Int. Cl. H01J 17/49

(52) U.S. Cl. 313/585

(57) ABSTRACT

A plasma display panel includes a rear substrate, a front substrate spaced from the rear substrate and forming a discharge space between the substrates, partition walls between the front and rear substrates sectioning the discharge space into red, green, and blue discharge cells including red, green, and blue light-producing fluorescent substances, so that the areas of the discharge cells are different from one another depending on a ratio of efficiencies of light radiation by the fluorescent substances. Address electrodes are located on the rear substrate, and discharge maintenance electrodes, having pairs of first and second electrodes, are located on the front substrate and extend in a direction crossing the address electrodes. First, second, and third transparent electrodes extend from the first and second electrodes over parts of the red, green, and blue discharge cells.

### BACKGROUND OF THE INVENTION

1. Field of the Invention

The present invention relates to a plasma display panel, and, more particularly, to a plasma display panel in which variation in radiation efficiencies of light of different colors is compensated by an improvement in the structure of partition walls separating discharge cells and transparent electrodes for generating discharges.

2. Description of the Related Art

Plasma display panels form an image of light radiated by exciting a fluorescent substance or a special gas. Examples of the plasma display device are disclosed in U.S. Pat. Nos. 5,182,489 and 5,841,232. Plasma display panels can be divided into AC, DC, and hybrid types.

An AC plasma display panel includes a rear substrate, a front substrate, electrodes, a dielectric layer, partition walls, and a fluorescent layer. The rear and front substrates are spaced from each other. The electrodes for generating a plasma discharge are present on at least one of the rear and front substrates in a pattern. The dielectric layer covers either the rear substrate or the front substrate and the electrodes are embedded in the dielectric layer. The partition walls have a pattern that defines separate discharge spaces where a plasma discharge occurs. The fluorescent layer coats respective discharge spaces defined by the partition walls. The discharge spaces are filled with a discharge gas for establishing plasma discharge including a mixture of xenon and helium and neon or helium and argon.

The partition walls include stripes spaced from each other in a lattice or zigzag shape. In a discharge space defined by partition walls arranged in a zigzag shape, the fluorescent layer coats two facing surfaces and a bottom surface of the discharge space. In a discharge space with lattice shaped partition walls, the fluorescent layer coats five surfaces, namely, four inner walls surrounding the discharge space and the bottom surface of the discharge space defined by the partition walls.

In the plasma display panels described, a plasma discharge is generated by the electrodes, that is, xenon is excited. Light having a wavelength of 147 nm is radiated when the excited xenon reaches a metastable state, and light having a wavelength of 170 nm is radiated from xenon molecules when the xenon pressure is high.

Examples of the fluorescent substances coating the discharge space include Y₂SiO₅:Ce and BaMgAl₁₄O₂₃:Eu for producing blue light, Zn₂SiO₄:Mn, BaAl₁₂O₁₉:Mn, and ZnAl₁₂O₁₉:Mn for producing green light, and Y₂SiO₅:Eu and (Y,Gd)BO₃:Eu for producing red light. The radiation efficiencies with respect to the excitation wavelength are about 0.43 for the fluorescent substance producing red light, about 0.4 for the fluorescent substance producing green light, and about 0.35 for the fluorescent substance producing red light with respect to the 147 nm wavelength resonance line of xenon. Although vacuum ultraviolet light of equal intensity is radiated from discharge spaces having the same area, the radiation efficiencies of the fluorescent substances with respect to the excitation wavelength are different. Accordingly, color purity deteriorates in the conventional plasma display panel.

To solve this problem, Korean Patent Publication No. 1999-69150 discloses a plasma display panel in which discharge maintenance electrodes are disposed across partition walls in stripes, corresponding to discharge spaces coated with fluorescent substances producing red, green, and blue light. The areas of the discharge maintenance electrodes increase in the order of the fluorescent substances producing red, green, and blue light. The areas of the electrodes are different but the areas coated with the red, green, and blue fluorescent substances are uniform, so that the strength of discharges can be different according to the color of the light produced. Thus, since the area coated with the fluorescent substance is uniform, there is a limit to the improvement of color purity that can be achieved.

### SUMMARY OF THE INVENTION

To solve the above-described problem, it is an object of the present invention to provide a plasma display panel in which the areas of the fluorescent substances and the areas of the electrodes vary so that color purity is improved and, simultaneously, white balance of an image can be improved.

It is another object of the present invention to provide a plasma display panel which can increase the margin of a voltage applied to discharge electrodes to excite fluorescent substances producing red, green and blue light by adjusting the areas of discharge spaces.

To achieve the above objects, there is provided a plasma display panel comprising a rear substrate; a front substrate spaced from the rear substrate and forming a discharge space between the rear and front substrates; partition walls between the front and rear substrates sectioning the discharge space into red, green, and blue discharge cells respectively having coatings of fluorescent substances producing red, green, and blue light, respectively, so that areas of the discharge cells differ in accordance with a ratio of efficiencies of light radiation by the respective fluorescent substances; address electrodes on the rear substrate; discharge maintenance electrodes, including pairs of first and second electrodes, on the front substrate and extending in a direction crossing the address electrodes; and first, second and third transparent electrodes extending from the first and second electrodes over at least parts of the red, green, and blue discharge cells, respectively.

It is preferred in the present invention that the areas of the first, second, and third transparent electrodes differ depending on a ratio of efficiency of radiation of red, green, and blue light from respective fluorescent substances in respective discharge cells where the first, second, and third transparent electrodes are disposed.

To achieve the above objects, a plasma display panel includes a rear substrate; a front substrate spaced from the rear substrate and forming a discharge space between the rear and front substrates; partition walls between the front and rear substrates and including main partition walls arranged in stripes spaced from each other and auxiliary partition walls transverse to and connected to the main partition walls, and defining red, green, and blue discharge cells having coatings of fluorescent substances respectively producing red, green, and blue light, so that the areas of the discharge cells differ in accordance with a ratio of efficiencies of light radiation by the fluorescent substances; address electrodes on the rear substrate; and pairs of first and second electrodes on the front substrate and extending in a direction crossing the address electrodes.

It is preferred in the present invention that the area of the discharge cell producing blue light is the largest among discharge cells producing red, green, and blue light.

It is preferred in the present invention that the first and second electrodes are parallel to the partition walls and do not cover the discharge cells, and that first, second, and third transparent electrodes extend from the first and second electrodes toward and at least partially over the discharge cells respectively producing red, green, and blue light.

### BRIEF DESCRIPTION OF THE DRAWINGS

The above objects and advantages of the present invention will become more apparent by describing in detail preferred embodiments with reference to the attached drawings in which:

FIG. 1 is an exploded perspective view of a plasma display panel according to the present invention;

FIG. 2 is a plan view schematically showing the structure of the partition walls of FIG. 1;

FIG. 3 is a plan view schematically showing the electrodes of FIG. 1;

FIG. 4 is a graph showing a change in brightness according to an increase in the horizontal length of the transparent electrode; and

FIGS. 5 and 6 are graphs showing the relationship between voltage and color temperature according to the area of a discharge space.

### DETAILED DESCRIPTION OF THE INVENTION

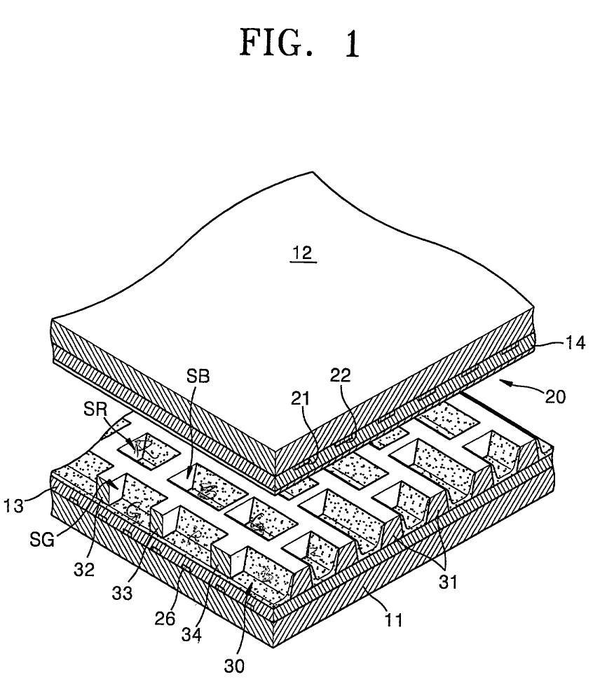

FIG. 1 shows the structure of a plasma display panel according to a preferred embodiment of the present invention. Referring to the drawing, the plasma display panel includes a rear substrate 11, a front substrate 12, an electrode structure 20, first and second dielectric layers 13 and 14, and partition walls 30. The rear substrate 11 and the front substrate 12 are spaced from each other to form a discharge space. The electrode structure 20 is located at the surfaces of the rear and front substrates 11 and 12, facing each other, for generating a preliminary discharge and a main discharge. The electrode structure 20 is embedded in the first and second dielectric layers 13 and 14. The partition walls 30 extend between the rear and front substrates 11 and 12 and define the discharge spaces.

The partition walls 30 are located on the upper surface of the first dielectric layer 13 of the rear substrate 11 and include main partition walls 31 and auxiliary partition walls 32, 33, and 34. The main partition walls 31 are stripes that are parallel to one another and have the same width. The auxiliary partition walls 32, 33, and 34 are transverse to and are connected to the main partition walls 31 and do not have uniform widths. The main and auxiliary partition walls define three discharge cells SR, SG, and SB. The centers of the three discharge cells are respectively arranged, generally, at the corners of a triangle, i.e., in a delta configuration.

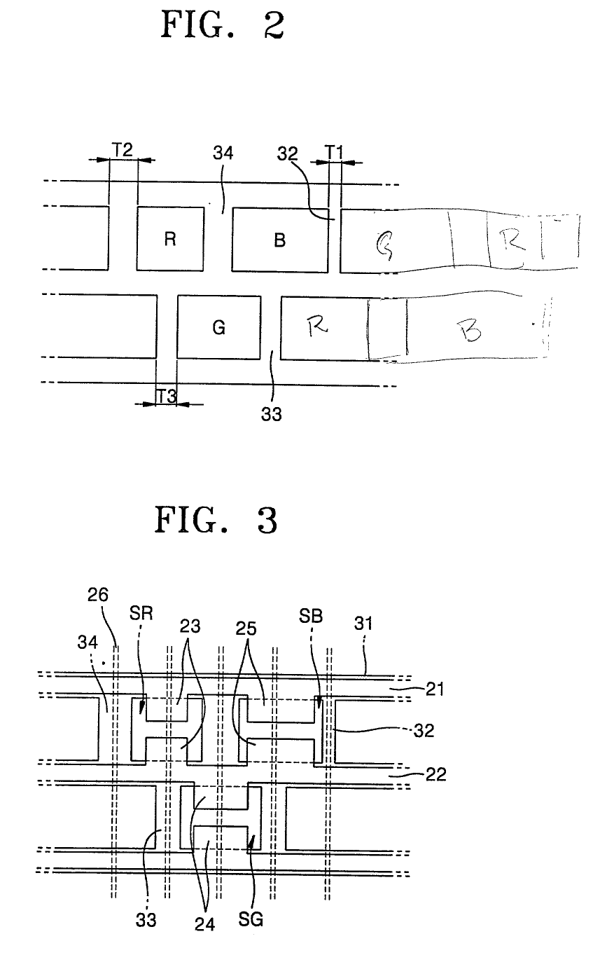

FIG. 2 shows the structure of the partition walls 30. Referring to the drawing, the auxiliary partition walls 32, 33, and 34 have different widths, T1, T2, and T3, respectively. Thus, the areas of the discharge cells are made different by the auxiliary partition walls 32, 33, and 34, in accordance with the efficiency of radiation of fluorescent substance in each of the discharge cells. In the embodiment of FIG. 2, the auxiliary partition walls 32 and 34 form two sides of the blue discharge cell SB, where a fluorescent substance producing blue light and exhibiting the lowest discharge efficiency is located. Auxiliary partition wall 32 is the narrowest of the auxiliary partition walls so that the discharge cell SB has the largest area. The auxiliary partition walls 34 forming two sides of the red discharge cell SR, where a fluorescent substance producing red light and exhibiting the highest discharge efficiency is located, are the widest auxiliary partition walls so that the red discharge cell SR has the smallest area. In the embodiment of FIG. 2, the discharge cell SG is defined at two sides by auxiliary partition walls 33 having a width intermediate the widths of the auxiliary partition walls 32 and 34. Adjustment of the relative areas of the discharge cells SR, SG, and SB in which the red, green, and blue fluorescent substances are located is not limited to the depicted embodiment. The desired arrangement of auxiliary partition walls of specific relative widths can be obviously achieved by changing the width of the main partition walls 31 and using different arrangements of the auxiliary partition walls having different widths. Preferably, the unit size of each discharge cell, including the light radiating area and one-half the width of each adjacent wall, is generally uniform to permit a uniform distribution of the three discharge cells SR, SG, and SB over a large area.

The discharge cells arranged in the delta configuration are respectively coated with red, green, and blue light-producing fluorescent substances. Y₂SiO:Ce and BaMgAl₁₄O₂₃:Eu can be used for the blue light-producing fluorescent substance, Zn₂SiO₄:Mn, BaAl₁₂O₁₉:Mn, and ZnAl₁₂O₁₉:Mn can be used for the green light-producing fluorescent substance, and Y₂SiO₅:Eu and (Y,Gd)BO₃:Eu can be used for the red light-producing fluorescent substance. The fluorescent substances are not limited to these preferred embodiments and any fluorescent material that can be excited without being deteriorated by ultraviolet light generated during a plasma discharge can be adopted.

The electrode structure 20 of FIG. 1, as shown in detail in FIG. 3, includes first and second electrodes 21 and 22, first, second, and third transparent electrodes 23, 24, and 25, and address electrodes 26. The first and second electrodes 21 and 22 are located, alternately, along the main partition walls 31. The first, second, and third transparent electrodes 23, 24, and 25 extend from the first and second electrodes 21 and 22 toward and partially over the respective discharge cells SR, SG, and SB. The address electrodes 26 are arranged in a predetermined pattern between the rear substrate 11 and the first dielectric layer 13, making substantially a right angle with the first and second electrodes 21 and 22.

The areas of the first, second, and third transparent electrodes 23, 24, and 25 can be different for each of the red, green, and blue discharge cells SR, SG, and SB. That is, the areas of the transparent electrodes disposed opposite respective discharge cells may be different depending on the efficiencies of radiation of red, green, and blue light by the fluorescent substances of the corresponding discharge cells.

The area of each transparent electrode opposite a discharge cell is determined by the horizontal length and the vertical length of each transparent electrode. The horizontal length of the transparent electrode means the length of the transparent electrode in the lengthwise direction of the first and second electrodes 21 and 22. The vertical length of the transparent electrode means the length of the transparent electrode extending transverse to the first or second electrode 21 or 22. Since, in the depicted embodiment, a pair of the transparent electrodes are disposed at each discharge cell and face each other, when the vertical length of each transparent electrode is large, the interval between the transparent electrodes decreases. When the intervals between the pairs of transparent electrodes disposed at each of the discharge cells are varied for the red, green, and blue discharge cells, firing voltages differ for each discharge cell. This variation in firing voltage produces a complicated problem because an unacceptable voltage variation occurs. Thus, preferably, in the plasma display panel according to the present invention, the areas of the transparent electrodes are determined by the horizontal length of each of the transparent electrodes, and the vertical lengths and the separations between pairs of electrodes at each discharge cell are uniform.

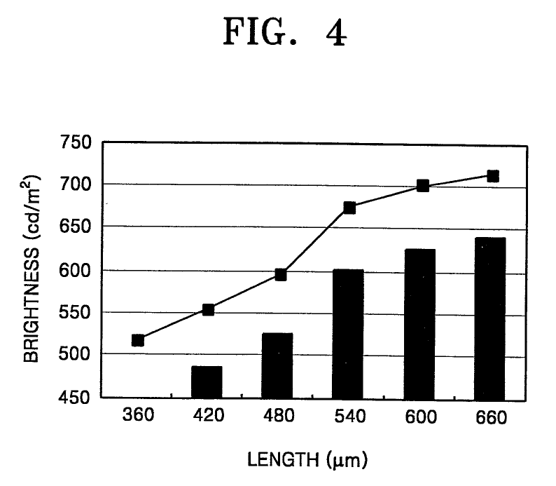

FIG. 4 shows the relationship between the horizontal length of a transparent electrode and the brightness of light radiated from a corresponding discharge cell. Referring to the drawing, it can be seen that brightness increases as the horizontal length of the transparent electrode increases. In FIG. 4, brightness produced by increasing the length of the transparent electrode in 60 μm steps is shown. When the length of the transparent electrode is increased to 540 μm from 480 μm, the rate of increase in brightness becomes maximum. Thus, in the present invention, the horizontal length of the third transparent electrode 25 disposed at the blue discharge cell SB, where the blue light-producing fluorescent substance exhibiting a relatively low brightness is present, is preferably 540 μm or more, or exactly 540 μm, at which the rate of increase in brightness is maximum.

The areas of the transparent electrodes preferably vary such that the ratio of the areas of the first, second, and third transparent electrodes 23, 24, and 25 disposed at the red, green, and blue discharge cells SR, SG, and SB, that is, the ratio of the horizontal lengths, is 0.65-0.7:0.9:1. These ratios compensate for differences in the brightnesses in the light produced by the respective fluorescent substances.

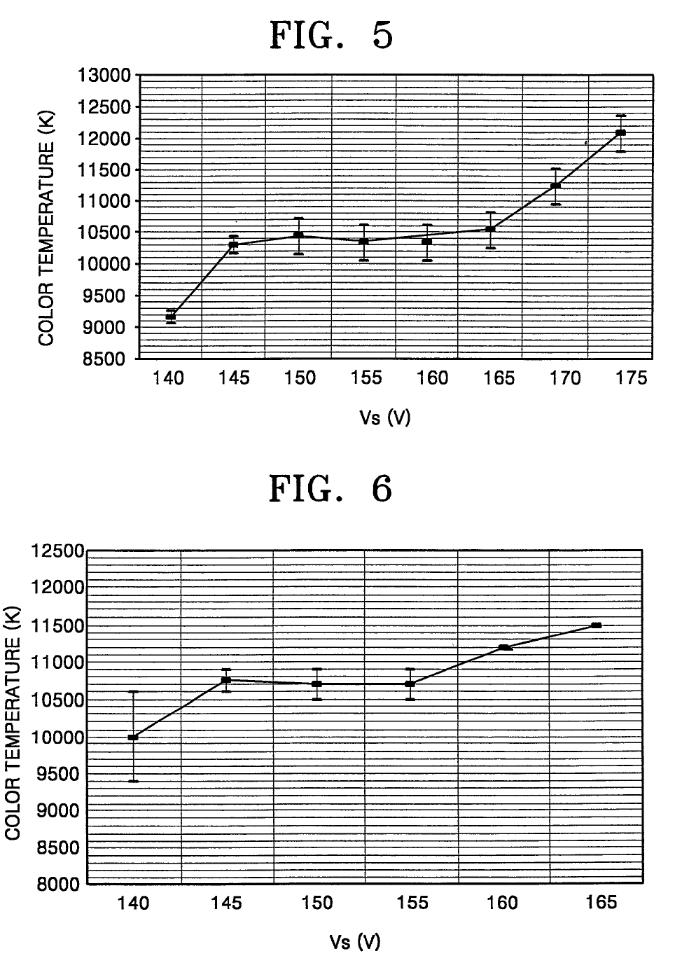

To obtain a most preferable ratio of the areas of the transparent electrodes, the present inventors experimented with the relationship between color temperature and the area of the transparent electrodes, producing the results shown in FIGS. 5 and 6.

FIG. 5 shows the relationship between color temperature and maintenance pulse voltage Vs when the horizontal lengths of the first, second, and third transparent electrodes 23, 24, and 25 are 350 μm, 465 μm, and 540 μm, respectively. Thus, the ratio of the horizontal lengths of the first, second, and third transparent electrodes 23, 24, and 25 is 0.65:0.86:1. FIG. 6 shows the relationship between color temperature and maintenance pulse voltage Vs when the horizontal lengths of the first, second, and third transparent electrodes 23, 24, and 25 are 390 μm, 540 μm, and 600 μm, respectively. Color temperature was measured as a function of the maintenance pulse voltage Vs by setting the ratio of the horizontal lengths of the first, second, and third transparent electrodes 23, 24, and 25, to about 0.65:0.9:1. As can be seen from the graphs, when the transparent electrodes have this latter ratio, color temperatures of the panel are all 10,000K or more. Thus, to compensate for degradation of brightness of blue light while maintaining a color temperature of at least 10,000K, the third transparent electrode 25, corresponding to the blue discharge cell SB, has a horizontal length of 540 μm or more. Preferably, the ratios of the horizontal lengths of the first, second, and third transparent electrodes 23, 24, and 25 are set to about 0.65:0.9:1. Of course, the ratio of the horizontal lengths of the first, second, and third transparent electrodes 23, 24, and 25 can be changed depending on the efficiency of light radiation by the respective fluorescent substances used.

In the operation of the plasma display panel having the described structure, according to the present invention, an input pulse voltage is applied to the address electrodes 26 and a preliminary discharge occurs in each discharge cell at each of the first electrode 21 or the second electrode 22 to which a scanning pulse voltage is applied. In response, plus charges are accumulated at discharge cell surfaces where the electrodes 21, 22, and 26, to which pulses have been applied, cross. In this state, when a maintenance pulse voltage is applied to the first and second electrodes 21 and 22, a maintenance discharge occurs at the first, second, and third transparent electrodes 23, 24, and 25, extending from the first and second electrodes 21 and 22. A maintenance pulse voltage is alternately applied to the first and second electrodes 21 and 22 so that the maintenance discharge is maintained. Ultraviolet light generated from the maintenance discharge excites the fluorescent substance in the respective discharge cell or cells. Then, visible light is generated from the excited fluorescent substance and radiated through the front substrate 12.

In the plasma display panel according to the present invention driven as described, since the areas of the discharge cells SR, SG, and SB are different, white balance, which depends on radiation from each fluorescent substance, can be improved. Since the area of the discharge cell SB where a blue light-producing fluorescent substance exhibiting a relatively low radiation efficiency, compared to the discharge cells SR and SG where red and green light-producing fluorescent substances are respectively present, is relatively larger than the red and green discharge cells, the quantity of blue light radiated is relatively increased. Since the area of the red discharge cell SR including the red light-producing fluorescent substance, exhibiting a relatively high radiation efficiency, is relatively smaller, the quantity of radiation can be relatively decreased. Thus, the strengths of the light emitted from the red, green, and blue light-producing fluorescent substances become identical so that white balance is improved.

Since the areas of the first, second, and third transparent electrodes 23, 24, and 25 disposed at the discharge cells SR, SG, and SB are different, in accordance with the efficiency of light radiation, differences in color concentration, according to the quantity of light radiated by the red, green, and blue light-producing fluorescent substances, are reduced. Since the area of the third transparent electrode 25 corresponding to the discharge cell SB where blue light is produced is made relatively larger, the area of the plasma discharge increases and thus the quantity of ultraviolet light increases, so that the lower radiation efficiency of the blue light-producing fluorescent substance is compensated.

The rear substrate where partition walls are located, according to the present invention, and a plasma display panel using the rear substrate improves radiation brightness by virtue of having a larger area where the fluorescent layer is present. By increasing the areas where the blue light-producing fluorescent substance, exhibiting a low radiation brightness, is present, degradation of radiation brightness of the blue light is prevented.

While this invention has been particularly shown and described with reference to preferred embodiments, it will be understood by those skilled in the art that various changes in form and details may be made without departing from the spirit and scope of the invention as defined by the appended claims.

What is claimed is:

1. A plasma display panel comprising:
a rear substrate;
a front substrate spaced from the rear substrate and forming a discharge space between the rear and front substrates;
partition walls between the front and rear substrates sectioning the discharge space into red, green, and blue discharge cells respectively having coatings of fluorescent substances producing red, green, and blue light, respectively, so that areas of the discharge cells differ in accordance with a ratio of efficiencies of light radiation by the respective fluorescent substances;
address electrodes on the rear substrate;
discharge maintenance electrodes, including pairs of first and second electrodes, on the front substrate and extending in a direction crossing the address electrodes; and
first, second and third transparent electrodes extending from the first and second electrodes over at least parts of the red, green, and blue discharge cells, respectively.

2. The plasma display panel as claimed in claim 1, wherein the areas of discharge cells are inversely proportional to the efficiencies of light radiation of the fluorescent substances of the red, green, and blue discharge cells.

3. The plasma display panel as claimed in claim 1, wherein the blue discharge cell has a larger area than the red and green discharge cells.

4. The plasma display panel as claimed in claim 1, wherein the areas of the first, second, and third transparent electrodes differ in accordance with the ratio of efficiencies of light radiation by the fluorescent substances of the red, green, and blue discharge cells where the first, second, and third transparent electrodes are respectively disposed.

5. The plasma display panel as claimed in claim 4, wherein the areas of the first, second, and third transparent electrodes are inversely proportional to the efficiencies of light radiation of the fluorescent substances of the red, green, and blue discharge cells.

6. The plasma display panel as claimed in claim 4, wherein the area of the third transparent electrode disposed partially over the blue discharge cell is larger than the areas of the first and second transparent electrodes.

7. The plasma display panel as claim in claim 4, wherein the areas of the first, second, and third transparent electrodes are in a ratio of approximately 0.65-0.7:0.9:1.

8. The plasma display panel as claimed in claim 1, wherein the areas of the respective discharge cells are determined by widths of the partition walls surrounding each discharge cell.

9. The plasma display panel as claimed in claim 8, wherein the areas of discharge cells are inversely proportional to the efficiency of light radiation of the fluorescent substances of the red, green, and blue discharge cells.

10. The plasma display panel as claimed in claim 8, wherein the area of the blue discharge cell is larger than the areas of the red and green discharge cells.

11. The plasma display panel as claimed in claim 8, wherein the partition walls include pairs of main partition walls parallel to each other, having the same width, and on which first and second electrodes are respectively disposed, and auxiliary partition walls having different widths, transverse to and connected to the main partition walls, defining the respective discharge spaces having different areas.

12. A plasma display panel comprising:
a rear substrate;
a front substrate spaced from the rear substrate and forming a discharge space between the rear and front substrates;
partition walls between the front and rear substrates and including main partition walls arranged in stripes spaced from each other and auxiliary partition walls transverse to and connected to the main partition walls, and defining red, green, and blue discharge cells having coatings of fluorescent substances respectively producing red, green, and blue light, so that the areas of the discharge cells differ in accordance with a ratio of efficiencies of light radiation by the fluorescent substances;
address electrodes on the rear substrate; and
pairs of first and second electrodes on the front substrate and extending in a direction crossing the address electrodes.

13. The plasma display panel as claimed in claim 12, wherein respective auxiliary partition walls have different widths and the areas of the discharge cells are determined by the different widths of the auxiliary partition walls.

14. The plasma display panel as claimed in claim 12, wherein the areas of discharge cells are inversely proportional to the efficiencies of light radiation of the fluorescent substances of the red, green, and blue discharge cells.

15. The plasma display panel as claimed in claim 12, wherein the blue discharge cell has a larger area than the areas of the red and green discharge cells.

16. The plasma display panel as claimed in claim 12, wherein the first and second electrodes are parallel to the main partition walls and do not cover the discharge cells, and including first, second, and third transparent electrodes extending from the first and second electrodes over at least parts of the red, green, and blue discharge cells, respectively.

17. The plasma display panel as claimed in claim 16, wherein the areas of the first, second, and third transparent electrodes differ in accordance with the ratio of efficiencies of light radiation by the fluorescent substances of the red, green, and blue discharge cells where the first, second, and third transparent electrodes are respectively disposed.

18. The plasma display panel as claimed in claim 17, wherein the areas of the first, second, and third transparent electrodes are inversely proportional to the efficiencies of light radiation of the fluorescent substances of the red, green, and blue discharge cells.

19. The plasma display panel as claimed in claim 17, wherein the area of the third transparent electrode disposed partially over the blue discharge cell is larger than the areas of the first and second transparent electrodes.

20. The plasma display panel as claim in claim 17, wherein the areas of the first, second, and third transparent electrodes are in a ratio of approximately 0.65-0.7:0.9:1.
